(19) United States
(12) Patent Application Publication
(10) Pub. No.: US 2026/0179071 A1
(43) Pub. Date: Jun. 25, 2026

(54) INTERCONNECTION OF POINT OF SALE TERMINALS AND CARD READER TERMINALS

(71) Applicant: PAYPAL, INC., San Jose, CA (US)

(72) Inventors: Dmitry Gorohov, Sollentuna (SE); Deeksha Arora, Panipat (IN); Usman Sattar Alvi, Upplands Väsby (SE)

(21) Appl. No.: 19/182,372

(22) Filed: Apr. 17, 2025

(30) Foreign Application Priority Data
Dec. 23, 2024 (IN) 202441102207

(51) Int. Cl. G06Q 20/20; H04L 67/12; H04W 76/38

(52) U.S. Cl. CPC G06Q 20/202; H04L 67/12; H04W 76/38

(57) ABSTRACT

The present invention relates to interconnection of Point of Sale, POS, terminals and card reader terminals. Especially, interconnection of POS terminals and card reader terminals via a cloud-based connection server is presented. A unique wireless connection, identified by a link ID, is established between each card reader terminal and the cloud-based connection server. The card reader terminals are configured to address the POS terminals using a channel ID concept. The POS terminals are configured to establish one connection to the cloud-based connection server per combination of link ID and channel ID.

### CROSS REFERENCE TO REALTED APPLICATION

The present invention claims priority to India Patent Application Serial No. 202441102207, filed December 23, 2024, all of which is incorporated herein by reference in its entirety.

### TECHNICAL FIELD

The present invention relates to interconnection of Point of Sale, POS, terminals and card reader terminals. Especially, interconnection of POS terminals and card reader terminals via a cloud-based connection server is presented.

### BACKGROUND

Setting up a system to handle card payments at a Point of Sale, POS, involves integrating necessary hardware, software, and payment processing services to enable seamless and secure transactions. Such a card payment system typically comprises a card reader terminal and a POS terminal. To enable card payments, the card payment system further comprises software that communicates with a payment backend. Such software is typically installed at the POS terminal. Setting up a card payment system is a critical part of modern business operations, enabling secure, convenient transactions and supporting various payment methods.

The card reader terminal can be configured to read card information by interacting with one or more of a magnetic stripe, an EMV chip and an NFC chip of a physical card or a virtual card of e.g. a mobile wallet. The POS terminal is a payment module of the merchant to which the payment terminal is connected and at which the payment typically is initiated. The connection between the card reader terminal and the POS terminal is typically implemented via a Bluetooth® connection. Such connection can however be a common point of failure. Further, a Bluetooth® connection has a limited range posing potential connection issues at the premises of the merchant, especially if the premises of the merchant is of considerable size and or if the premises of the merchant has many rooms.

### BRIEF DESCRIPTION OF THE DRAWINGS

The above and other aspects will now be described in more detail, with reference to appended figures. The figures should not be considered limiting; instead they are used for explaining and understanding.

As illustrated in the figures, the sizes of layers and regions may be exaggerated for illustrative purposes and, thus, are provided to illustrate the general structures. Like reference numerals refer to like elements throughout.

FIG. 1 illustrates, by way of example, a card payment system interconnecting a card reader terminal and a POS terminal, also a card payment workflow for the card payment system is illustrated.

FIG. 2 illustrates, by way of example, a cloud-based connection server being connected to a plurality of card reader terminals and a plurality of POS terminals.

FIG. 3 illustrates, by way of example, a card reader terminal connection record of the cloud-based connection server illustrated in FIG. 2

FIG. 4 illustrates, by way of example, a POS terminal connection record of the cloud-based connection server illustrated in FIG. 2

FIG. 5 illustrates, by way of example, establishment/assignment of a link ID to a card reader terminal.

FIG. 6 illustrates, by way of example, establishment of a card reader terminal connection between a card reader terminal and a cloud-based connection server.

FIG. 7 illustrates, by way of example, establishment of a POS terminal connection between a POS terminal and a cloud-based connection server.

FIG. 8 is a diagram illustrating a computing system, which may correspond to either of a card reader terminal or a POS terminal.

### DETAILED DESCRIPTION

The present invention will now be described more fully hereinafter with reference to the accompanying drawings, in which currently preferred embodiments of the invention are shown. This invention may, however, be embodied in many different forms.

It is to be understood that the terminology used herein is for purpose of describing particular embodiments only, and is not intended to be limiting. It must be noted that, as used in the specification and the appended claim, the articles "a", "an," "the," and "said" are intended to mean that there are one or more of the elements unless the context clearly dictates otherwise. Thus, for example, reference to "a unit" or "the unit" may include several devices, and the like. Furthermore, the words "comprising", “including”, “containing” and similar wordings do not exclude other elements or steps.

It is an object of the present invention to provide interconnection of POS terminals and card reader terminals via a cloud-based connection server. The interconnection being platform agnostic. Further, the interconnection allowing multiple card reader terminals connecting to one or more POS terminals. Moreover, the interconnection allowing multiple POS terminals connecting to one or more card reader terminals.

Hence, the present invention relates to interconnection of Point of Sale, POS, terminals and card reader terminals. Especially, interconnection of POS terminals and card reader terminals via a cloud-based connection server is presented. A unique wireless connection, identified by a link ID, is established between each card reader terminal and the cloud-based connection server. The card reader terminals are configured to address the POS terminals using a channel ID concept. The POS terminals are configured to establish one connection to the cloud-based connection server per combination of link ID and channel ID.

According to a first aspect a cloud-based connection server configured to manage a message flow between one or more Point of Sale, POS, terminals and one or more card reader terminals is provided. The cloud-based connection server comprises a database, a payments module, and a message dispatcher. The database is configured to maintain a card reader terminal connection record. Each entry in the card reader terminal connection record indicates a card reader terminal connection at which the respective one of the one or more card reader terminals is accessible and a link ID associated with a respective one of the one or more card reader terminals. The database is further configured to maintain a POS terminal connection record comprising one or more POS terminal connections. Each POS terminal connection is a POS terminal connection to one of the one or more POS terminals and is associated with a unique link ID and one or more channel IDs. Each channel ID is an identifier utilized by the cloud-based connection server to decide routing of messages from a card reader terminal to one or more POS terminals. The payments module is configured to handle a payment request received from a POS terminal by facilitating an interaction between a dedicated one of the one or more card reader terminals and a payments backend until a transaction completes or is aborted. The one of the one or more card reader terminals is identified by the link ID in a payment request message from the POS terminal. The message dispatcher is configured to relay messages between the one or more POS terminals, the one or more card reader terminals and the payments module. The relaying is based on the information in the card reader terminal connection record and in the POS terminal connection record and the information in the messages received by the cloud-based connection server.

The cloud-based connection server allows one POS terminal to many card reader terminal communications. Accordingly, multi-pay, one POS terminal initiating individual payment to many card reader terminals may be implemented using the cloud-based connection server. Further, the cloud-based connection server allows one card reader terminal to many POS terminal communications. This may be used to notify all POS terminals that the card reader terminal is busy with executing a payment started from one of POS terminals. Alternatively, or in combination, this may be used to notify about the battery level of the card reader terminal. The communication between POS terminal(s) and card reader terminal(s) are not dependent on a specific communication protocol, such as Bluetooth®, between the POS terminal and the card reader terminal. Instead, the POS terminal(s) and card reader terminal(s) may be connected to the cloud-based connection server using e.g. a WiFi connection. This allow for platform agnostic connection between POS terminal(s) and card reader terminal(s). Further, this allow for a more stable and more long-range connection between POS terminal(s) and card reader terminal(s). This may facilitate implementation of a card payment system in e.g. restaurants.

The message dispatcher may be configured to relay a received message to one of the one or more card reader terminals based on a link ID contained in the received message.

The message dispatcher may be configured to relay a received message to one or more of the one or more POS terminals based a channel ID contained in the received message.

Each of the card terminal connections and the POS terminal connections may be associated with an expiry time at which the respective connection expires.

The link ID associated with the respective one of the one or more card reader terminals may be a unique link ID.

Each of the card terminal connections and the POS terminal connections may be established over a WiFi connection or over a mobile network connection.

Each of the card terminal connections and the POS terminal connections may be a bidirectional communication protocol allowing communication both from and to the cloud-based connection server.

The payments module may be configured to maintain a communication between cloud-based connection server and a dedicated card reader terminal to drive the payment.

According to a second aspect a method of linking a card reader terminal to a merchant organization comprising one or more Point of Sale, POS, terminals is provided. The method according to the second aspect comprises: sending, from the card reader terminal to a cloud-based connection server , a linking request, the cloud-based connection server being configured to bidirectionally manage message flow between the one or more POS terminals and the card reader terminal; generating, at the cloud-based connection server and in response to the linking request, a link ID and a secret code associated with the link ID; storing, in a database of the cloud-based connection server, the link ID and the secret code associated with the link ID; distributing the link ID and the secret code to the card reader terminal and the one or more POS terminals; requesting a card reader terminal connection through which the card reader terminal is able to bidirectionally communicate with the cloud-based connection server; and associating, in the database of the cloud-based connection server, the card reader terminal connection with the link ID.

The method according to the second aspect may further comprise, at the card reader terminal, generating the linking request by: generating, a public key from a private key, the private key being stored at the card reader terminal, generating a nonce, encrypting the nonce into a signature using the private key, including the public key, the nonce and the signature into the linking request.

The method according to the second aspect may further comprise, at the cloud-based connection server validating the linking request by decrypting the signature using the public key and comparing the decrypted signature with the nonce.

The method according to the second aspect may further comprise, at the card reader terminal, generating the linking request on a condition that a link ID is not already stored in a memory of the card reader terminal.

Sending, from the card reader terminal to the cloud-based connection server, the linking request may be made using an address being prestored in a memory of the card reader terminal.

Requesting the card reader terminal connection may comprise: generating, at the card reader terminal, a challenge based on the link ID and the secret code and encrypting the challenge using the private key; sending the encrypted challenge from the card reader terminal to the cloud-based connection server; verifying, at the cloud-based connection server, the challenge with the public key; generating the card terminal connection; storing the card reader terminal connection in the database as being associated with the link ID; and sending the card reader terminal connection to the card reader terminal.

According to a third aspect a method of connecting a Point of Sale, POS, terminal to a cloud-based connection server is presented. The cloud-based connection server being configured to bidirectionally manage message flow between the POS terminal and one or more card reader terminals. The method according to the third aspect comprises: receiving, at the POS terminal, a respective link ID identifying the one or more card reader terminals to which the POS terminal is able to connect to; sending, from the POS terminal to the cloud-based connection server, one or more POS terminal connection requests, each POS terminal connection request comprising a link ID to one of the one or more card reader terminals and one or more channel IDs over which the POS terminal is allowed to receive messages; generating, at the cloud-based connection server, a POS terminal connection for each unique link ID and one or more channel IDs; storing, in a POS terminal connection record in a database of the cloud-based connection server, a POS terminal connection entry for each generated POS terminal connection, wherein each POS terminal connection entry comprises the generated POS terminal connection and the unique link ID and the one or more channel IDs; and providing the POS terminal with the generated POS terminal connection(s).

The method according to the third aspect may further comprise authenticating the POS terminal at an authentication service server.

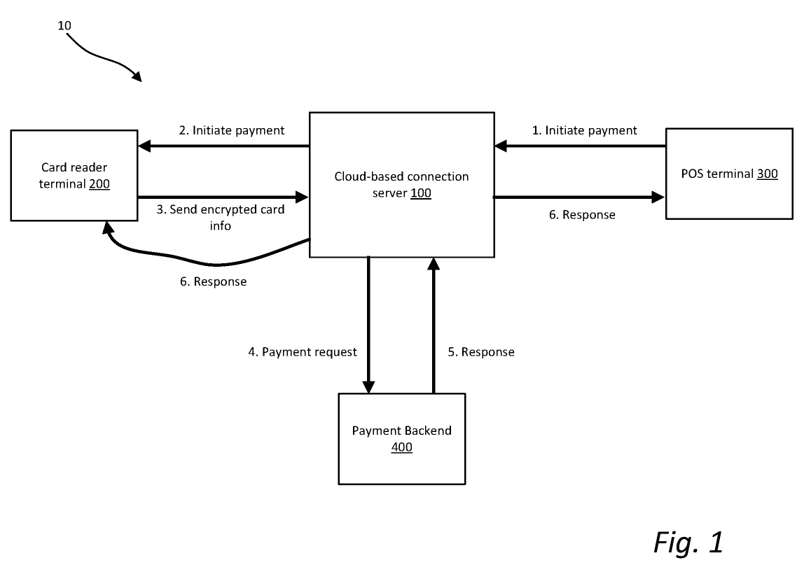

FIG. 1 illustrates, by way of example, a card payment system 10 according to the present disclosure. The card payment system 10 comprises a point of sale, POS, terminal 300 and a card reader terminal 200. The POS terminal 300 and the card reader terminal 200 are configured to communicate with each other via a cloud-based connection server 100. By the implementation of the cloud-based connection server 100 the POS terminal 300 and the card reader terminal 200 may be made platform agnostic. At least as long as they can be configured to connect to and communicate with the cloud-based connection server 100. The cloud-based connection server 100 is configured to manage a message flow between the POS terminal 300 and the card reader terminal 200. The message flow between the POS terminal 300 and the card reader terminal 200 may be bidirectional. Hence, the cloud-based connection server 100 is configured to act as a proxy, facilitating message exchange between the POS terminal 300 and card reader terminal 200. As will be discussed in greater detail below, the cloud-based connection server 100 may manage a message flow between one or more POS terminals 300 and one or more card reader terminals 200. Hence, the cloud-based connection server 100 allow for a plurality of card reader terminals 200 to be connected to one or more POS terminals 300. Further, the cloud-based connection server 100 allow for a plurality of POS terminals 300 to be connected to one or more card reader terminals 200. The cloud-based connection server 100 may be seen as a transitive layer which transfers data between the POS terminal 300 and the card reader terminal 200. In case of the data being encrypted the cloud-based connection server 100 does typically not encrypt any data.

The POS terminal 300 may be based on any platform capable of establishing a connection to the cloud-based connection server 100. In the following a connection between a POS terminal 300 and the cloud-based connection server 100 will be referred to as a POS terminal connection. Typically, the POS terminal connection is established over a WiFi connection between the POS terminal 300 and the cloud-based connection server 100. Hence, the POS terminal 300 comprises a WiFi based communication module. Alternatively, or combination, the card reader terminal connection is established over a mobile communication connection. Hence, the card reader terminal 200 may comprises a mobile communication module. According to one example, the POS terminal connection is established based on a WebSocket.

The card reader terminal 200 may be based on any platform capable of establishing a connection to the cloud-based connection server 100. In the following a connection between a card reader terminal 200 and the cloud-based connection server 100 will be referred to as a card reader terminal connection. Typically, the card reader terminal connection is established over a WiFi connection between the card reader terminal 200 and the cloud-based connection server 100. Hence, the card reader terminal 200 may comprise a WiFi based communication module. Alternatively, or combination, the card reader terminal connection is established over a mobile communication connection. Hence, the card reader terminal 200 may comprises a mobile communication module. According to one example, the card reader terminal connection is established based on a WebSocket. The card reader terminal 200 comprises a payments application with EMV kernels supporting major card brands such as Europay, Visa and Mastercard.

The card reader terminal 200 may be implemented using any appropriate combination of hardware and/or software. The card reader terminal 200 may include any appropriate combination of hardware and/or software having one or more processors and capable of reading instructions stored on a tangible non-transitory machine-readable medium for execution by the one or more processors. The card reader terminal 200 may include a machine-readable medium, such as a memory that includes instructions for execution by one or more processors for causing the card reader terminal 200 to perform specific tasks. For example, such instructions may include a payment application that may allow a merchant or customer to use the card reader terminal 200 to authorize a payment. The payment application may be configured to interface with the the cloud-based connection server 100 authorize payments processed by the cloud-based connection server 100.

The card reader terminal 200 may also include one or more merchant applications. In some embodiments, merchant applications may be applications that allow a merchant or buyer to use the card reader terminal 200 in the POS system 10. Merchant applications may include any applications that allow a merchant or customer to, scan goods and/or services to create a bill of sale or invoice, and then pay for the items using the payment application and/or a card reader. Merchant applications may allow a merchant to accept various credit, gift, or debit cards, cash, or payment processing service providers, such as PayPal, Inc., of San Jose, Calif., such as may be provided by the cloud-based connection server 100, for payment for items.

The card reader terminal 200 may include other applications as may be desired in one or more embodiments to provide additional features available. For example, such other applications may include interfaces and communication protocols that allow a merchant or customer to receive and transmit information to and from the cloud-based connection server 100 and possibly other online sites. Such other applications may also include security applications for implementing client-side security features, programmatic client applications for interfacing with appropriate APIs or various other types of generally known programs and/or applications. Such other applications may include mobile applications downloaded and resident on the card reader terminal 200 that enables merchants and customers to access content through such other applications.

In connection with FIG. 1 also a card payment workflow for the card payment system 10 disclosed therein is illustrated. A payment is initiated at the POS terminal 300. The initiated payment is relayed to the card reader terminal 200 by the cloud-based connection server 100. At the card reader terminal 200 a customer is asked to swipe, insert or tap its card (physical or virtual). As a response card info is extracted at the card reader terminal 200. Encrypted card info is sent to the cloud-based connection server 100. The cloud-based connection server 100 comprises a payments module configured to facilitate an interaction between the card reader terminal 200 and a payments backend 400 until a transaction completes or is aborted. The payments backend 400 carries out an authorization of payment by engaging with an acquirer. The payments backend 400 is also sending a response for handling logging of a payment within the POS terminal 300 and/or the card reader terminal 200. Hence, approval or decline of the payment is relayed to the POS terminal 300 and/or the card reader terminal 200. The POS terminal 300 and/or the card reader terminal 200 may thereafter print or email a receipt.

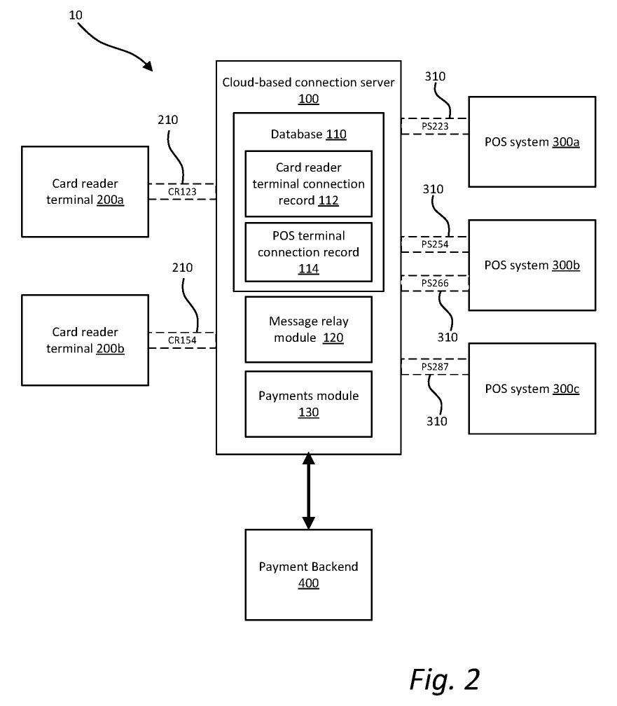

In connection with FIG. 2 the cloud-based connection server 100 will be discussed in more detail. As mentioned above, the cloud-based connection server 100 acts as a proxy, facilitating message exchange between POS terminal(s) 300 and card reader terminal(s) 200. Hence, the cloud-based connection server 100 is configured to manage a message flow between one or more POS terminals 300 and one or more card reader terminals 200. The cloud-based connection server 100 comprises a database 110, a message dispatcher 120 and a payments module 130.

The cloud-based connection server 100 may be a payment processing service provider server that may be maintained by a payment processing service provider, such as PayPal, Inc. of San Jose, Calif. It is however understood that the cloud-based connection server 100 may be maintained by other service providers. The cloud-based connection server 100 may also be maintained by an entity with which sensitive credentials and information may be exchanged with the one or more POS terminals 300 and the one or more card reader terminals 200. The cloud-based connection server 100 may be more generally a web site, an online content manager, a service provider, such as a bank, or other entity who provides content to a user requiring user authentication or login.

The cloud-based connection server 100 may be maintained by an online payment provider or payment processing provider, which may provide processing for online financial and payment transactions on behalf of users including merchants and customers. The payments module 130 is configured to interact with applications on the one or more POS terminals 300 and the one or more card reader terminals 200 to receive and process transactions. The payments module 130 may store and retrieve financial information. The cloud-based connection server 100 may include other applications, such as may be provided for authenticating users to the cloud-based connection server 100, for performing financial transactions, and for processing payments. The cloud-based connection server 100 may also be in communication with one or more external databases, that may provide additional information that may be used by the cloud-based connection server 100. Such databases maintained by third parties, and may include third party financial information of merchants and customers.

The herein discussed modules and applications may be software implementations that performs a function when executed by one or more processors or Application Specific Integrated Circuit (ASIC) or other circuit having memory and at least one processor for executing instructions to perform a function, such as the functions described as being performed by the described applications/modules.

The communication among the POS terminal(s) 300, the cloud-based connection server 100 and the card reader terminal(s) 200 occurs through POS terminal connection(s) 310 and card reader terminal connection(s) 210. Each card reader terminal 200 is connected to the cloud-based connection server 100 via a dedicated card reader terminal connection 210. Hence, there is one card reader terminal connection 210 per card reader terminal 200. Each POS terminal 300 may be connected to the cloud-based connection server 100 via one or more POS terminal connections 310. This allow for one-to-one connection between a single POS terminal 300 and a plurality of card reader terminals 200.

Each POS terminal connection 310 and each card reader terminal connection 210 may be in one of three phases: 1. Connection established, i.e. when the connection has just been set up. 2. Connection active, i.e. when the connection is open and actively receiving messages. 3. Connection closed, i.e. when the cloud-based connection server 100 closes the connection. Typically, an established connection is set to be active for a time in the order of hours. According to one specific example an expiry time of a connection is set to be two (2) hours.

The card terminal connections 210 and the POS terminal connections 310 may be a bidirectional communication protocol allowing communication both from and to the cloud-based connection server 100. The card reader terminal connections 210 and the POS terminal connections 310 may be established as WebSocket connections. WebSockets provide a full-duplex communication channel over a single connection between a client and a server. Unlike traditional HTTP, which follows a request-response model, WebSockets allow for real-time, two-way communication, making them ideal for applications requiring low latency and instant updates.

The database 110 of the cloud-based connection server 100 is configured to maintain a card reader terminal connection record 112 and a POS terminal connection record 114. According to one example, Dynamo DB may be used for implementing the database 110. Dynamo DB was selected for its capability of supporting multi-region replication through Global Tables.

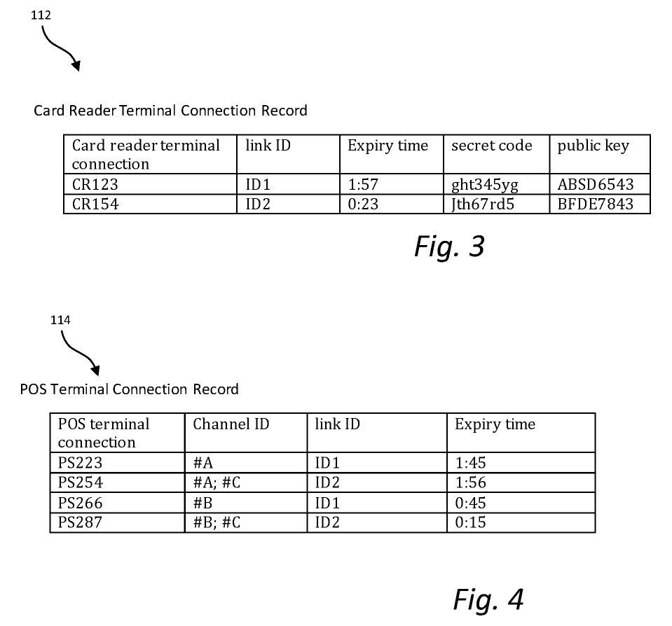

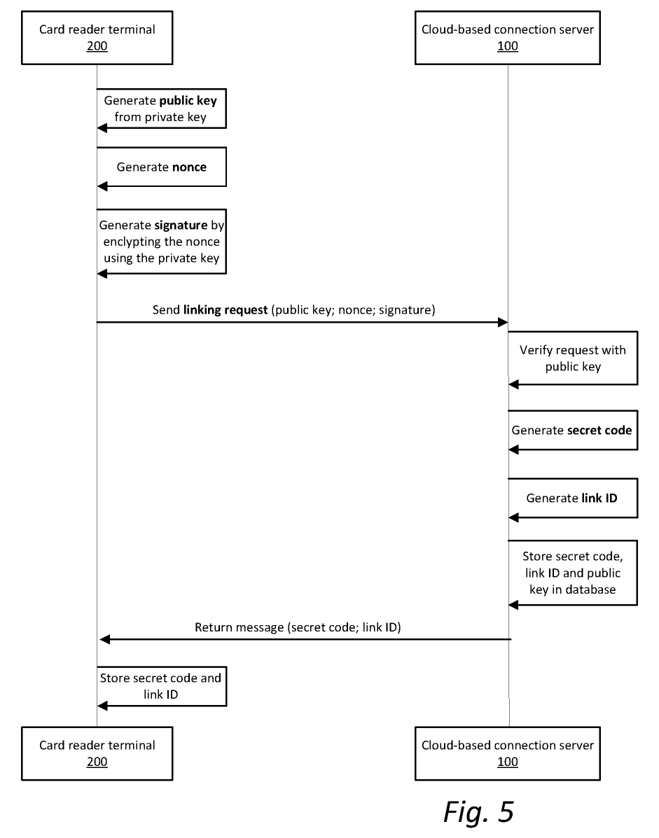

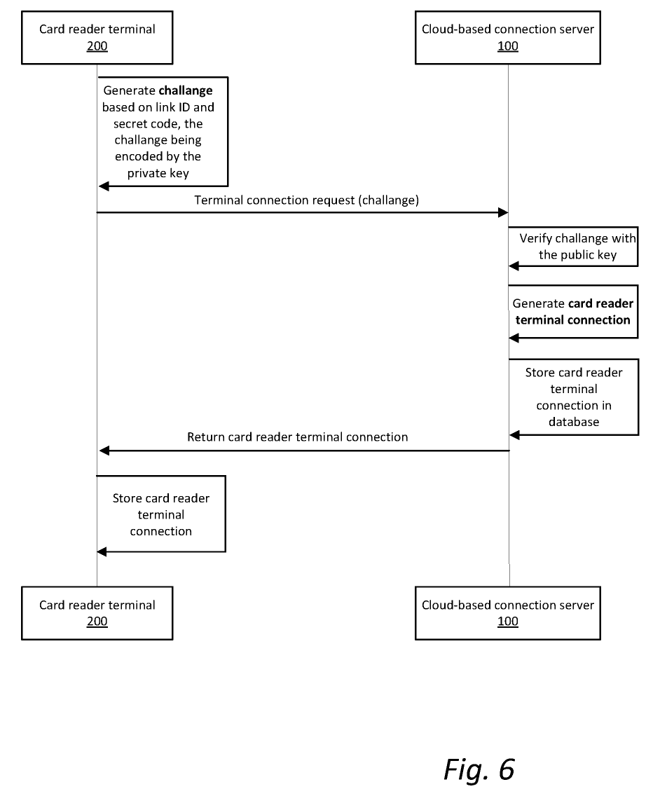

An example of a card reader terminal connection record 112 is illustrated in connection with FIG. 3. The card reader terminal connection record 112 of FIG. 3 is a card reader terminal connection record 112 of the card reader terminal connections 210 between the card reader terminals 200 and the cloud-based connection server 100 of FIG. 2. Each entry in the card reader terminal connection record 112 indicates a card reader terminal connection 210 at which the respective one of the one or more card reader terminals 200 is accessible and a link ID associated with a respective one of the one or more card reader terminals 200. The link ID is a unique ID for each card reader terminal 200. The link ID is set to identify a relationship between a card reader terminal 200 and a merchant organization. The establishment of a link ID will be discussed in more detail below in connection with FIG. 5. Each entry in the card reader terminal connection record 112 may further comprise an expiry time for the specific card reader terminal connection 210. Once the expiry time runs out a new card reader terminal connection 210 between the card reader terminal 200 and the cloud-based connection server 100 is to be established. The establishment of a card reader terminal connection 210 will be discussed in more detail below in connection with FIG. 6. Both in the process of establishing a link ID and a card reader terminal connection 210 a public key and a secret code are used. The public key and the secret code are typically stored for each entry in the card reader terminal connection record 112.

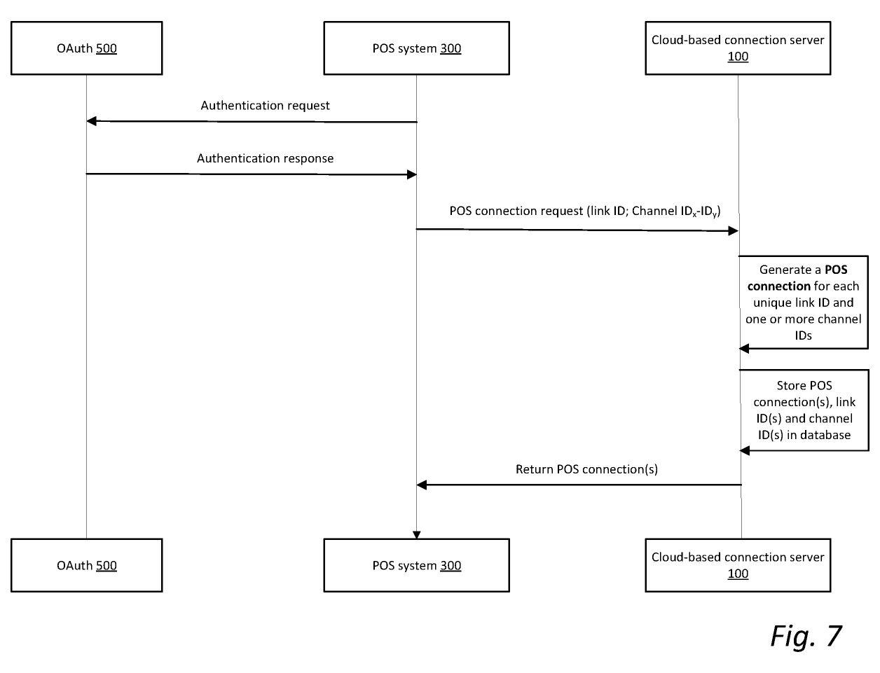

An example of a POS terminal connection record 114 is illustrated in connection with FIG. 4. The POS terminal connection record 114 of FIG. 4 is a POS terminal connection record 114 of the POS terminal connections 310 between the POS terminals 300 and the cloud-based connection server 100 of FIG. 2. Each entry in the POS terminal connection record 114 indicates a POS terminal connection 310 to one of the one or more POS terminals 300. A specific POS terminal 300 may have more than one POS terminal connection 310 to the cloud-based connection server 100. Each POS terminal connection 310 is set-up for a unique link ID and one or more channel IDs. A channel ID serves as the identifier that the cloud-based connection server 100 utilizes to decide the routing of messages from a card reader terminal 200 to one or more POS terminals 300. A specific channel ID may be used to address more than one POS terminal 300. That is, a POS terminal connection 310 is set-up for each link ID and one or more channel IDs. In the in FIGS. 2 and 4 illustrated example, POS system 300a may be reached over channel ID #A, POS system 300b may be reached over channel ID #A, channel ID #B and channel ID #C, and POS system 300c may be reached over channel ID #B and channel ID #C, and. Further, each entry in the POS terminal connection record 114 may further comprise an expiry time for the specific POS terminal connection 310. Once the expiry time runs out a new POS terminal connection 310 between the POS terminal 300 and the cloud-based connection server 100 is to be established. The establishment of a POS terminal connection 310 will be discussed in more detail below in connection with FIG. 7.

The payments module 130 of the cloud-based connection server 100 is configured to handle a payment request received from a POS terminal 300 by facilitating an interaction between one of the one or more card reader terminals 200 and the payments backend 400 until a transaction completes or is aborted. The payments backend 400 carries out the authorization of payments by engaging with the acquirer and logging the transaction within the POS system 10. A Transaction is to be aborted due to any issues or errors from the acquirer. Hence, the payments module 130 is responsible for maintaining communication between cloud-based connection server 100 and a dedicated one of the card reader terminals 200 to drive a payment. The dedicated one of the card reader terminals 200 is the card reader terminals 200 dedicated to handle the interaction with the customer for completing the payment.

The message dispatcher 120 of the cloud-based connection server 100 is a core component. Its primary role is to examine received messages and determine its intended destination. The message dispatcher 120 decides whether the message should be processed through an internal path or forwarded to a designated target. The message dispatcher 120 is configured to relay messages between the one or more POS terminals 300, the one or more card reader terminals 200 and the payments module 130. The message dispatcher 120 is configured to relay a message from one of the one or more POS terminals 300 to one of the one or more card reader terminals 200 based on the link ID contained in the message. The message dispatcher 120 is configured to relay a message from one of the one or more card reader terminals 200 to one or more of the one or more POS terminals 300 based the channel ID contained in the message. The message dispatcher 120 is configured to relay a payment request being sent from a POS terminal and forward it, based on a link ID, to the card reader terminal 200 associated with the link ID and/or to the payments module 130. Once the message dispatcher 120 identifies a card payment workflow, it may create a context where it holds information about the dedicated card reader terminal 200 and or the POS terminal, e.g. serial number, link ID, channel ID. This context will be used by the payments module 130 to complete the card payment workflow.

Hence, the message dispatcher 120 in combination with the payments module 130 are configured to handle the card payment workflow illustrated in connection with FIG. 1. During the handling of the card payment workflow for a specific payment/transaction, the payments module 130 is configured to maintain a communication between cloud-based connection server 100 and a dedicated card reader terminal 200 among the one or more card reader terminals 200 to drive the payment/transaction. Such communication is maintained based on the link ID for the dedicated card reader terminal 200.

The payments module 130 may be conceptualized as a state machine. There are number phases it can currently be in: initiate phase, awaiting state, progress phase, completion phase, and failure phase.

Upon the payments module 130 being in the initiate phase. To initiate the payment process, the payments module 130 sends a request to dedicated card reader terminal 200 to obtain necessary transaction details, see item 2 in FIG. 1. Once the request is dispatched, the state machine awaits a response from the dedicated card reader terminal 200 for this specific command. The requested information may comprise a serial number and firmware version of the card reader terminal 200. This information may be needed for the payments backend to execute the transaction. Once the command is received by the dedicated card reader terminal 200, it displays the amount of the purchase on a display thereof and prompts the customer to provide a card. Until the customer taps or swipes or inserts the card, the card at the card reader terminal 200, the payments module 130 remains in an awaiting state. It awaits an authorization message sent by the card reader terminal 200. The authorization message is a request from the card reader terminal 200 asking the payments module 130 to request online authorization for the card payment from the payments backend 400 in order to complete it.

Upon occurrence of the authorization message, the payments module 130 triggers a Payments Backend request. The Payments Backend 400 logs the payment, ensuring its availability in the back office. Following this, an authorization request is sent to the acquirer. The response from the acquirer can confirm the success of the transaction by validating aspects such as the card's legitimacy, non-expiry status, availability of funds for the transaction, and absence of any additional actions needed on the merchant's card.

In the case, for example, when the acquirer requests the customer to insert the card to validate their PIN, the Payments Backend 400 should issue the specific command to the card reader terminal 200 as a response. When receiving a response from the Payments Backend 400, the payments module 130 send it to the card reader terminal 200 to be executed on. The card reader terminal 200 react to this by switching the message asking to insert the card and by awaiting the customer to insert the card and provide the PIN. After everything is fulfilled by the card reader terminal 200, another authorization message is emitted to the payments module 130.

Upon receiving the authorization message twice, both the payments module 130 and the payments backend 400 will be able to identify that it concerns the same transaction. If no actions were requested by the acquirer, in most cases, the payments backend 400 instructs the payments module 130 to execute a transaction complete command on the card reader terminal 200. After executing transaction complete command, the card reader terminal 200 will emit a transaction complete event to the payments module 130 to switch the payments module 130 to a completion phase of the transaction.

Upon receiving the transaction complete command from the payments module 130 to execute the transaction complete event, the card reader terminal 200 will complete the transaction and display the message "Success". Following this, card reader terminal 200 will send the transaction complete event to the payments module 130. Once the transaction complete event is received at the payments module 130, the subsequent action involves finalizing the transaction on the card reader terminal 200. The payments module will request finish for the transaction from the payments backend 400 and then transmit the finish transaction command to the card reader terminal 200. Upon the execution of the finish transaction command, the card reader terminal 200 will send a response to the payments module 130 confirming the successful execution of the command.

The subsequent task is to present the message "Thank you" on the card reader terminal 200 display screen. The payments module 130 is responsible for issuing another command to the card reader terminal 200 to display this message.

When encountering any transaction failures, payments module 130 enters into failure phase in which it performs two actions: notify the card reader terminal 200 and/or the POS terminal 300 to trigger a transaction cancel event, and inform the Payments Backend 400 to abort the transaction process.

The establishment/assignment of a link ID to a card reader terminal 200 will now be discussed in connection with FIG. 5. The establishment/assignment of a link ID to a card reader terminal 200 will also link the card reader terminal 200 to a merchant organization comprising one or more POS terminals 300. The process of establishing/assigning a link ID to a card reader terminal 200 comprises a number of steps/actions which will be elaborate upon with reference to FIG. 5. The card reader terminal 200 is sending a linking request to the cloud-based connection server 100. The linking request being a request for the cloud-based connection server 100 to generate a link ID for the card reader terminal 200. The card reader terminal 200 may have an address to the cloud-based connection server 100 prestored in an internal memory of the card reader terminal 200. The address to the cloud-based connection server 100 may be stored in the memory of the card reader terminal 200 upon manufacturing or dispatching of the card reader terminal 200. Hence, it may be seen as the card reader terminal 200 has embedded therein an address to the cloud-based connection server 100. The card reader terminal 200 may be configured to generate the linking request on a condition that a valid link ID is not already stored in a memory of the card reader terminal. By the link ID being valid is meant that it is stored at the card reader terminal 200 and that it has not expired. A link ID may expire at the same time as a card reader terminal connection expires 210. The linking request may comprise one or more of a public key, a nonce and a signature. The public key may be generated from a private key being prestored at the card reader terminal 200. The nonce may be generated as a random byte array. The nonce may be encrypted into the signature. The encrypting may be made using the private key. The public key, the nonce and the signature may be included into the linking request.

The cloud-based connection server 100 is configured to, in response to the linking request, generate a link ID. Possibly also a secret code associated with the link ID is generated at the cloud-based connection server 100. The link ID and the secret code associated with the link ID are stored at the card reader terminal connection record 112 at the database 110 of the cloud-based connection server 100. Before generating the link ID and the thereto associated secret code the linking request may be verified/validated at the cloud-based connection server 100. Verifying/validating the linking request may be made by decrypting the signature using the public key and comparing the decrypted signature with the nonce. Hence, in order to verify/validate the key pair of the card reader terminal 200, the card reader terminal 200 may encrypt a random byte array using its private key and provide both the unencrypted version “nonce” as well as the encrypted version “signature” in the linking request. The cloud-based connection server 100 may use the public key, which also is provided in the linking request, to verify the validity of the key pair. The public key may also be stored in the card reader terminal connection record 112 at the database 110 of the cloud-based connection server 100. The stored public key being associated with the generated link ID and secret code.

The cloud-based connection server 100 is sending the link ID and the secret code to the card reader terminal 200 which stores the link ID and the secret code locally in the memory of the card reader terminal 200. The cloud-based connection server 100 may further distribute the link ID to the one or more POS terminals 300 being associated with the merchant organization. This may be facilitated by an API endpoint service which the one or more POS terminals 300 may call. The API endpoint service may then provide a list of connected card reader terminal 200 and possibly their serial numbers.

The establishment of a card reader terminal connection 210 will now be discussed in more detail in connection with FIG. 6. Once, the card reader terminal 200 has received the link ID and the secret code it is configured to request a card reader terminal connection 210 through which the card reader terminal 200 is able to bidirectionally communicate with the cloud-based connection server 100. The card reader terminal 200 may request the card reader terminal connection 210 as a challenge to be sent to the cloud-based connection server 100. The challenge may be generated based on the link ID and the secret code. The challenge may be encoded by the private key. The card reader terminal 200 is sending the encrypted challenge to the cloud-based connection server 100. The cloud-based connection server 100 is verifying the challenge with the public key. Upon positive verification, the cloud-based connection server 100 is generating the card terminal connection 210. Once generated, the card reader terminal connection 210 is stored in the card reader terminal connection record 112 in the database 110 of the cloud-based connection server 100. The stored card reader terminal connection 210 is associated with the link ID comprised in the challenge. The cloud-based connection server 100 is further sending the generated card reader terminal connection 210 to the card reader terminal 200. Possibly, the cloud-based connection server 100 is also sending an expiry time for the generated card reader terminal connection210. The expiry time for the generated card reader terminal connection210 is typically also stored in the card reader terminal connection record 112. The card reader terminal 200 is typically locally storing the card reader terminal connection210.

The establishment of one or more POS terminal connections 310 between a POS terminal 300 and the cloud-based connection server 100 will now be discussed in more detail in connection with FIG. 7. A mentioned above, a POS terminal connection 310 is a connection between a POS terminal 300 and the cloud-based connection server 100. Each POS terminal 300 may establish more than one POS terminal connection 310. This since one POS terminal connection 310 per unique Link ID and one or more Channel IDs is to be established. As discussed above in connection with FIG. 6, upon a Link ID is generated at the cloud-based connection server 100, it distributes the link ID to the one or more POS terminals 300 being associated with the merchant organization. Hence, the POS terminal 300 receives information identifying the one or more card reader terminals 200 to which the POS terminal 300 is able to connect to. The POS terminal 300 is sending one or more POS terminal connection requests to the cloud-based connection server 100. Each POS terminal connection request comprises a link ID to one of the one or more card reader terminals 200 and one or more channel IDs over which the POS terminal 300 is allowed to receive messages. It is up to POS terminal 300 to define the number of channels and hence, the number of channel IDs. During pairing with a card reader terminal 200, the POS terminal 300 provides the list of channel IDs to use. In any communication between a POS terminal 300 and a card reader terminal 200, whatever message the POS terminal 300 sends it contains a destination link ID of the intended card reader terminal 200 and a channel ID. After the message is received by the card reader terminal 200 and processed, the response message would contain same link ID and channel ID.

At the cloud-based connection server 100 a POS terminal connection is generated for each unique link ID and one or more channel IDs. A POS terminal connection entry for each generated POS terminal connection 310 is stored in the POS terminal connection record 114 of the database 112 of the cloud-based connection server 100. Hence, each POS terminal connection entry comprises the generated POS terminal connection 310 and the unique link ID and the one or more channel IDs. Once the one or more POS terminal connections 310 have been generated at the cloud-based connection server 100 it/they is/are sent to the POS terminal 300 that requested the one or more POS terminal connections 310. Hence, the POS terminal 300 is provided with the POS terminal connection 310 generated for the specific POS terminal 300.

Before the establishment of one or more POS terminal connections 310 between a POS terminal 300 and the cloud-based connection server 100 the POS terminal 300 may be authenticating itself at an authentication service server 500. This process is also illustrated in connection with FIG. 7.

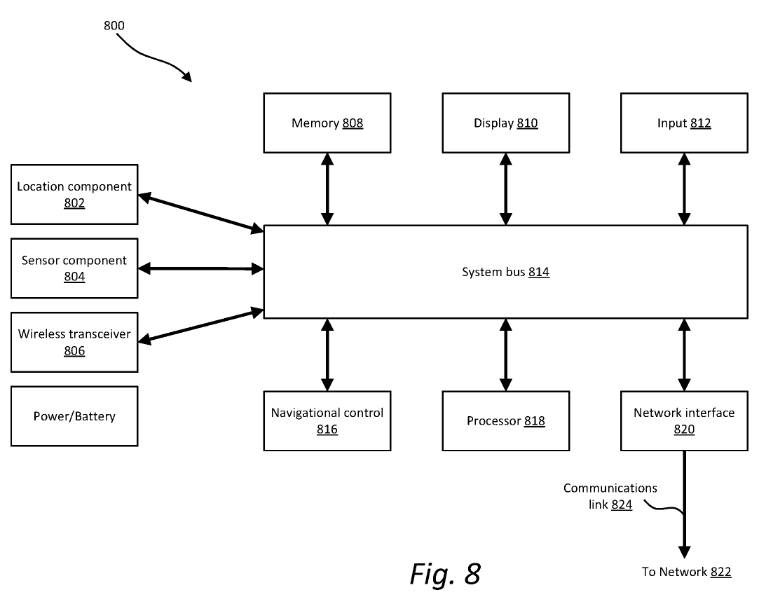

FIG. 8 is a diagram illustrating a computing system 800, which may correspond to either of a card reader terminal 200 or a POS terminal 300. The computing system 800 may be a mobile device such as a smartphone, a tablet computer, a stationary computer, a dedicated card reader terminal, and the like. The computing system 800 comprises a network interface component (NIC) 820 configured for communication with a network. The NIC 820 includes a wireless communication component, such as a wireless broadband component, a wireless satellite component, or various other types of wireless communication components including radio frequency (RF), and/or microwave frequency (MWF) configured for communication with a network 822. The NIC 720 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 822.

The computing system 800 may comprise a system bus 814 for interconnecting various components within the computing system 800 and communicating information between the various components. Such components include a processing component 818, which may be one or more processors, micro-controllers, graphics processing units (GPUs) or digital signal processors (DSPs), and a memory component 808, which may correspond to a random-access memory (RAM), an internal memory component, a read-only memory (ROM), or an external or static optical, magnetic, or solid-state memory. The computing system 800 further may comprise a display component 810 for displaying information to a user of the computing system 800. The display component 810 may be a liquid crystal display (LCD) screen, an organic light emitting diode (OLED) screen (including active matrix AMOLED screens), an LED screen, a plasma display, or a cathode ray tube (CRT) display. The computing system 800 may also include an input component 812, allowing for a user of the computing system 800, to input information to the computing system 800. Such information could include payment information such as an amount required to complete a transaction, account information, authentication information such as a credential, or identification information. The input component 812 may include, for example, a keyboard or key pad, whether physical or virtual. The computing system 800 may further comprise a navigation control component 816, configured to allow a user to navigate along the display component 810. The navigation control component 816 may be a mouse, a trackball, or other such device. Moreover, if the computing system 800 includes a touch screen, the display component 810, the input component 812, and the navigation control 816 may be a single integrated component, such as a capacitive sensor-based touch screen.

The computing system 800 may further include a location component 802 for determining a location of the computing system 800. The location component 802 may correspond to a GPS transceiver that is in communication with one or more GPS satellites. Alternatively, or in combination, the location component 802 may be configured to determine a location of computing system 800 by using an internet protocol (IP) address lookup, or by triangulating a position based on nearby telecommunications towers, wireless access points (WAPs), or BLE beacons. The location component 802 may be further configured to store a user-defined location in the memory component 808 that can be transmitted to a third party for the purpose of identifying a location of the computing system 800. The computing system 800 may also include sensor components 804. Sensor components 804 provide sensor functionality, and may correspond to sensors built into the computing system 800 or sensor peripherals coupled to the computing system 800. The sensor components 804 may include any sensory device that captures information related to the computing system 800 or a merchant or customer using the computing system 800 and any actions performed using the computing system 800. The sensor components 804 may include camera and imaging components, accelerometers, biometric readers, GPS devices, motion capture devices, and other devices. The computing system 800 may also include one or more wireless transceivers 806 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, etc.

The computing system 800 may perform specific operations by the processing component 818 executing one or more sequences of instructions contained in the memory component 808. Alternatively, or in combination, hard-wired circuitry may be used in place of or in combination with software instructions to implement the present disclosure. Logic may be encoded in a computer readable medium, which may refer to any medium that participates in providing instructions to the processing component 818 for execution, including the memory component 808. The computer readable medium may be tangible and non-transitory. In various implementations, non-volatile media include optical or magnetic disks, volatile media includes dynamic memory, and transmission media includes coaxial cables, copper wire, and fiber optics, including wires that comprise the system bus 814. Transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Execution of instruction sequences to practice the present disclosure may be performed by the computing system 800. In various other embodiments of the present disclosure, a plurality of computing systems 800 coupled by a communication link 824 to the network 822 (e.g., such as a LAN, WLAN, PTSN, and/or various other wired or wireless networks, including telecommunications, mobile, and cellular phone networks) may perform instruction sequences to practice the present disclosure in coordination with one another. The computing system 800 may transmit and receive messages, data and one or more data packets, information and instructions, including one or more programs (i.e., application code) through the communication link 824 and the network interface component 820 and/or the wireless transceiver 806. Received program code may be executed by the processing component 818 as received and/or stored in the memory component 808.

The computing system 800 may include more or less components than shown in FIG. 8. For example, the components shown in FIG. 8 may be directly coupled to one or more other components in FIG. 8, eliminating a need for the system bus 814. Furthermore, components shown in FIG. 8 may be shown as being part of a unitary system 800, but may also be part of a distributed system where the components are separate but coupled and in communication. In general, the components shown in FIG. 8 are shown as examples of components in a computing system 800 capable of performing embodiments disclosed herein. However, a computing system 800 may have more or fewer components and still be capable of performing some embodiments disclosed herein.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A cloud-based connection server configured to manage a message flow between one or more Point of Sale, POS, terminals and one or more card reader terminals, the cloud-based connection server comprising:
a database configured to:
maintain a card reader terminal connection record wherein each entry in the card reader terminal connection record indicates a card reader terminal connection at which the respective one of the one or more card reader terminals is accessible and a link ID associated with a respective one of the one or more card reader terminals, and
maintain a POS terminal connection record comprising one or more POS terminal connections, wherein each POS terminal connection is a POS terminal connection to one of the one or more POS terminals and is associated with a unique link ID and one or more channel IDs, wherein each channel ID is an identifier utilized by the cloud-based connection server to decide routing of messages from a card reader terminal to one or more POS terminals;
a payments module configured to handle a payment request received from a POS terminal by facilitating an interaction between one of the one or more card reader terminals and a payments backend until a transaction completes or is aborted; and
a message dispatcher configured to relay messages between the one or more POS terminals, the one or more card reader terminals and the payments module based on the information in the card reader terminal connection record and in the POS terminal connection record and the information in the messages received by the cloud-based connection server.

2. The cloud-based connection server according to claim 1, wherein the message dispatcher is configured to relay a received message to one of the one or more card reader terminals based on a link ID contained in the received message.

3. The cloud-based connection server (100) according to claim 1, wherein the message dispatcher is configured to relay a received message to one or more of the one or more POS terminals based a channel ID contained in the received message.

4. The cloud-based connection server according to claim 1, wherein each of the card terminal connections and the POS terminal connections is associated with an expiry time at which the respective connection expires.

5. The cloud-based connection server according to claim 1, wherein the link ID associated with the respective one of the one or more card reader terminals is a unique link ID.

6. The cloud-based connection server according to claim 1, wherein each of the card terminal connections and the POS terminal connections is established over a WiFi connection or a mobile communication connection.

7. The cloud-based connection server according to claim 6, wherein each of the card terminal connections and the POS terminal connections is a bidirectional communication protocol allowing communication both from and to the cloud-based connection server.

8. The cloud-based connection server according to claim 7, wherein each of the card terminal connections and the POS terminal connections are implemented as websockets.

9. The cloud-based connection server according to claim 1, wherein the payments module is configured to maintain a communication between cloud-based connection server and a dedicated card reader terminal to drive the payment.

10. A method of linking a card reader terminal to a merchant organization comprising one or more Point of Sale, POS, terminals, the method comprising:
sending, from the card reader terminal to a cloud-based connection server, a linking request, the cloud-based connection server being configured to bidirectionally manage message flow between the one or more POS terminals and the card reader terminal;
generating, at the cloud-based connection server and in response to the linking request, a link ID and a secret code associated with the link ID;
storing, in a database of the cloud-based connection server, the link ID and the secret code associated with the link ID;
distributing the link ID and the secret code to the card reader terminal and the one or more POS terminals;
requesting a card reader terminal connection through which the card reader terminal is able to bidirectionally communicate with the cloud-based connection server; and
associating, in the database of the cloud-based connection server, the card reader terminal connection with the link ID.

11. The method according to claim 10, further comprising:
at the card reader terminal, generating the linking request by:
generating, a public key from a private key, the private key being stored at the card reader terminal,
generating a nonce,
encrypting the nonce into a signature using the private key,
including the public key, the nonce and the signature into the linking request; and
at the cloud-based connection server validating the linking request by decrypting the signature using the public key and comparing the decrypted signature with the nonce.

12. The method according to claim 10, further comprising, at the card reader terminal, generating the linking request on a condition that a link ID is not already stored in a memory of the card reader terminal.

13. The method according to claim 10, wherein sending, from the card reader terminal to the cloud-based connection server, the linking request is made using an address being prestored in a memory of the card reader terminal.

14. The method according to claim 10, wherein requesting the card reader terminal connection comprises:
at the card reader terminal, generating a challenge based on the link ID and the secret code and encrypting the challenge using the private key;
sending the encrypted challenge from the card reader terminal to the cloud-based connection server;
at the cloud-based connection server, verifying the challenge with the public key;
generating the card terminal connection;
storing the card reader terminal connection in the database as being associated with the link ID;
sending the card reader terminal connection to the card reader terminal.

15. The method according to claim 9, further comprising associating the card terminal connection with an expiry time at which the card terminal connection expires.

16. The method according to claim 9, wherein the card terminal connection is implemented as a websocket.

17. A method of connecting a Point of Sale, POS, terminal to a cloud-based connection server, the cloud-based connection server being configured to bidirectionally manage message flow between the POS terminal and one or more card reader terminals, the method comprising:
receiving, at the POS terminal, a respective link ID identifying the one or more card reader terminals to which the POS terminal is able to connect to;
sending, from the POS terminal to the cloud-based connection server, one or more POS terminal connection requests, each POS terminal connection request comprising a link ID to one of the one or more card reader terminals and one or more channel IDs over which the POS terminal is allowed to receive messages;
at the cloud-based connection server, generating a POS terminal connection for each unique link ID and one or more channel IDs;
storing, in a POS terminal connection record in a database of the cloud-based connection server, a POS terminal connection entry for each generated POS terminal connection, wherein each POS terminal connection entry comprises the generated POS terminal connection, the unique link ID and the one or more channel IDs;
providing the POS terminal with the generated POS terminal connection(s).

18. The method according to claim 17, further comprising authenticating the POS terminal (300) at an authentication service server.

19. The method according to claim 17, further comprising associating the POS terminal connection(s) with an expiry time at which the respective POS terminal connection expires.

20. The method according to claim 17, wherein the POS terminal connection(s) is/are implemented as a respective websocket.
